(19) United States
(12) Patent Application Publication
(10) Pub. No.: US 2016/0042430 A1
(43) Pub. Date: Feb. 11, 2016

(54) RECOMMENDING MEDICAL APPLICATIONS BASED ON A PHYSICIAN-PATIENT ENCOUNTER

(71) Applicant: Practice Fusion, Inc., San Francisco, CA (US)

(72) Inventors: Matthew Christopher Douglass, San Francisco, CA (US); Stefan Mills Klocek, Berkeley, CA (US)

(73) Assignee: Practice Fusion, Inc., San Francisco, CA (US)

(21) Appl. No.: 14/454,319

(22) Filed: Aug. 7, 2014

(51) Int. Cl. G06Q 30/06; G06F 19/00

(52) U.S. Cl. CPC G06Q 30/0631; G06F 19/3443

(57) ABSTRACT

In an embodiment, a computer-implemented method helps a physician prescribe a medical application to a patient. In the method, a plurality of medical applications are activated in an EHR system. Then, a request to retrieve medical applications for an encounter between the physician and the patient is received. Based on the medical information describing the encounter and feature information associated with the respective medical application, the EHR system filters the plurality of medical applications to generate a suggested list of medical applications. Finally, the suggested list of medical applications is output to a device for display.

### BACKGROUND

1. Field

This field is generally related to integration of medical applications with electronic health record systems to recommend medical applications based on a physician-patient encounter.

2. Background

### Electronic Health Records

Medical records related to a patient's health information are essential to the practice of medical care. Traditionally, medical records were paper-based documents. The emergence of electronic medical records (EMR), which are digital version of the paper chart that contains all of a patient's medical history from one medical practice, offers medical professionals and patients with new functionalities and efficiencies that paper-based medical records cannot provide. An electronic health record (EHR), also known as an electronic medical record (EMR), is a collection of electronically stored information about an individual patient's medical history. EHRs may contain a broad range of data, including demographics, medical history, medication history, allergies, immunization records, laboratory test results, radiology images, vital signs, personal statistics like age and weight, and billing information. Many commercial EHR systems combine data from a number of health care services and providers, such as clinical care facilities, laboratories, radiology centers, and pharmacies.

EHRs are a drastic improvement over paper-based medical records. Paper-based medical records require a large amount of physical storage space. Paper records are often stored in different locations, and different medical professionals may each have different and incomplete records about the same patient. Obtaining paper records from multiple locations for review by a health care provider can be time consuming, complicated, and sometimes impossible. In contrast, EHR data is stored in digital format, and thus are more secure and can be accessed from anywhere. EHR systems significantly simplify the reviewing process for health care providers. Because records in EHRs can be linked together, EHRs vastly improve the accessibility of health records and the coordination of medical care.

EHRs also decrease the risk of misreading errors by health care professionals. Poor legibility is often associated with handwritten, paper medical records, which can lead to medical errors. EHRs, on the other hand, are inherently legible given that they are typically stored in typeface. In addition, electronic medical records enhance the standardization of forms, terminology and abbreviations, and data input, which help ensure reliability of medical records, and standardization of codesets and storage of EHR data means that data from different technical information systems can be displayed in a single, unified record. Further, EHRs can be transferred electronically, thus reducing delays and errors in recording prescriptions or communicating laboratory test results.

The benefits of digitizing health records are substantial. Health care providers with EHR systems have reported better outcomes, fewer complications, lower costs, and fewer malpractice claim payments. But despite EHRs' potential in drastically improving the quality of medical care, only a low percentage of health care providers use EHR systems. While the advantages of EHRs are significant, they also carry concerns, including high costs, lost productivity during EHR implementation or computer downtime, and lack of EHR usability.

The Health Insurance Portability and Accountability Act (HIPAA), enacted in the U.S. in 1996, and as amended, established rules for use and access of protected health information (PHI). HIPAA provides restrictions on disclosure of and access to protected health information to and by third parties. HIPAA applies to information in electronic medical records, such as health information doctors and nurses input, documented conversations between a doctor and a patient, and information use to process or facilitate medical billing claims and documents. The HIPAA Security Rule, effective on Apr. 20, 2005 for most covered entities, adds additional constraints to electronic data security and the storage and transmission of PHI.

The high cost of EHRs also significantly hinders EHR adoption. A large number of physicians without EHRs have referred to initial capital costs as a barrier to adopting EHR systems. Cost concerns are even more severe in smaller health care settings, because current EHR systems are more likely to provide cost savings for large integrated institutions than for small physician offices. During the EHR technology's setup and implementation process, productivity loss can further offset efficiency gains. The need to increase the size of information technology staff to maintain the system adds even more costs to EHR usages.

Usability is another major factor that holds back adoption of EHRs. It is particularly challenging to develop user-friendly EHR systems. There is a wide range of data that needs to be integrated and connected. Complex information and analysis needs vary from setting to setting, among health care provider groups, and from function to function within a health care provider group. To some providers, using electronic medical records can be tedious and time consuming, and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHRs in revolutionizing the health care system, calls for better EHR systems that are secure, cost-effective, efficient, and user-friendly.

Comprehensive EHR systems can provide capabilities far beyond simply storing patients' medical records. Because EHR systems offer health care providers and their workforce members the ability to securely store and utilize structured health information, EHR systems can have a profound impact on the quality of the health care system. In Framework for Strategic Action on Health Information Technology, published on Jul. 21, 2004, the Department of Health & Human Services (HHS) outlined many purposes for EHR services. The outlined purposes include, among other things, improving health care outcomes and reducing costs, reducing recordkeeping and duplication burdens, improving resource utilization, care coordination, active quality and health status monitoring, reducing treatment variability, and promoting patients' engagement in and ownership over their own health care.

Recent legislation has set goals and committed significant resources for health information technology (IT). One of the many initiatives of the American Recovery and Reinvestment Act of 2009 (ARRA) was “to increase economic efficiency by spurring technological advances in science and health.” The Health Information Technology for Economic and Clinical Health (HITECH) Act, passed as a part of ARRA, allocated billions of dollars for health care providers to adopt and meaningfully use EHRs in their practices. HITECH also mandates the Office of the National Coordinator for Health Information Technology (ONC) to define certification criteria for “Certified EHR Technology.”

EHR systems satisfying “Certified EHR Technology” criteria are capable of performing a wide range of functions, including: entry and storage, transmission and receipt of care summaries, clinical decision support, patient lists and education resources, generation of public health submission data, and patient engagement tools. Entry and storage is related to the ability to enter, access and modify patient demographic information, vital signs, smoking status, medications, clinical and radiology laboratory orders and results. Transmission and receipt of care summaries involve the ability to receive, incorporate, display and transmit transition of care/referral summaries. Clinical decision support features configurable clinical decision support tools, including evidence-based support interventions, linked referential clinical decision support, and drug-drug and drug-allergy interaction checks. Patient lists and education resources include the ability to create patient lists based on problems, medications, medication allergies, demographics and laboratory test result values, and the ability to identify patient-specific education resources based on such data elements. Generating public health submission data allows users to create electronic immunization and syndromic surveillance data files that can be submitted to public health agencies. Patient engagement tools allow medical professionals to grant patients with an online means to view, download and transmit their health information to a third party, provide patients with clinical summaries after office visits, and facilitate secure-doctor patient messaging.

Medical applications include software medical applications and hardware medical devices. For example, software medical applications help patients diagnosed with arthritis to record pain levels. Also, hardware devices allow patients to measure their blood glucose levels on their own. Medical applications are a growing field in the health care industry. Thousands of medical applications are currently available, and the number is increasing rapidly.

### BRIEF SUMMARY

In an embodiment, a computer-implemented method presents a patient-related medical application marketplace. In the method, a plurality of medical applications are activated in an EHR system. Then, a request for browsing the medical application marketplace is received. Based on medical information describing health of the patient and feature information associated with the plurality of medical applications, the EHR system filters the plurality of medical applications to generate a recommended list of medical applications. Finally, the recommended list of medical applications is output to a device for display to the patient.

In another embodiment, a computer-implemented method presents a physician-related medical application marketplace. In the method, a plurality of medical applications are activated in the EHR system. Then, a request for browsing the medical application marketplace is received. Based on medical information describing practice of the physician and feature information associated with the plurality of medical applications, the EHR system filters the plurality of medical applications to generate a recommended list of medical applications. Finally, the recommended list of medical applications is output to a device for display to the physician.

In yet another embodiment, a computer-implemented method helps a physician prescribe a medical application to a patient. In the method, a plurality of medical applications are activated in an EHR system. Then, a request to retrieve medical applications for an encounter between the physician and the patient is received. Based on the medical information describing the encounter and feature information associated with the respective medical application, the EHR system filters the plurality of medical applications to generate a suggested list of medical applications. Finally, the suggested list of medical applications is output to a device for display.

System and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1A is a flowchart illustrating a method for providing a patient-related medical application marketplace.

FIG. 1B is a flowchart illustrating a method for providing a physician-related medical application marketplace.

FIG. 2 shows a screen illustrating a marketplace interface that displays a recommended list of medical applications to the physician, as a result of the method described in FIG. 1B, according to some embodiments.

FIG. 3 shows an exemplary screen in the marketplace that displays additional details of a medical application selected by the physician.

FIG. 4 is a flowchart illustrating a method for a physician to prescribe a medical application to a patient during an encounter between the physician and the patient.

FIG. 5 shows a screen illustrating a prescription interface that displays a suggested list of medical applications, as the result of the method described FIG. 4, according to some embodiments.

FIG. 6 is a flowchart illustrating a method for ensuring that the patient has purchased or downloaded the prescribed medical application and monitoring the patient's usage of the prescribed medical application, according to some embodiments.

FIG. 7 is a diagram illustrating an example system for providing medical application marketplaces and for helping a physician to prescribe medical applications to patients during physician-patient encounters.

FIG. 8 is a diagram illustrating an example computing device.

The drawing in which an element first appears is typically indicated by the leftmost digit or digits in the corresponding reference number. In the drawings, like reference numbers may indicate identical or functionally similar elements.

### DETAILED DESCRIPTION

Finding a medical application is often difficult for a potential buyer (e.g., a patient or a physician). A potential buyer often must visit multiple websites and browse through many medical applications to identify the ones that are helpful. The browsing experience can be time-consuming and sometimes cause the potential buyer to give up early after going through too many medical applications that are irrelevant to the potential buyer's medical situation.

A related challenge occurs in prescribing medical applications. Sometimes, a physician wants to prescribe a medical application to a patient to help the treatment of the patient. Searching and finding a suitable medical application becomes even harder for the physician during the short time of a physician-patient encounter (e.g., a scheduled office visit). In addition, no effective ways currently exist to ensure that the patient complies with the physician's prescription to purchase or download the prescribed medical application.

To address these issues, embodiments introduce features that integrate the medical applications into the EHR system. The EHR system can present a medical application marketplace to a user. The user may be a patient who logs into a personally controllable health record (PCHR) system connected to the EHR system. The user may also be a physician using the EHR system. Medical applications in the marketplace are specifically tailored to the users' medical situations, based on medical data already stored in the EHR system. The EHR system can also suggest a list of potential medical applications for a physician to prescribe to a patient, based on the information specific to an encounter between the physician and the patient. Some embodiments allow the physician to complete the prescription of a medical application with one single click. The ease of prescription saves the physician's time so that the physician can focus on other more important tasks during the physician-patient encounter. After the encounter, the EHR system can periodically check whether the patient has purchased, downloaded, or authorized the medical application to verify compliance with the prescription.

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Medical Application Marketplace

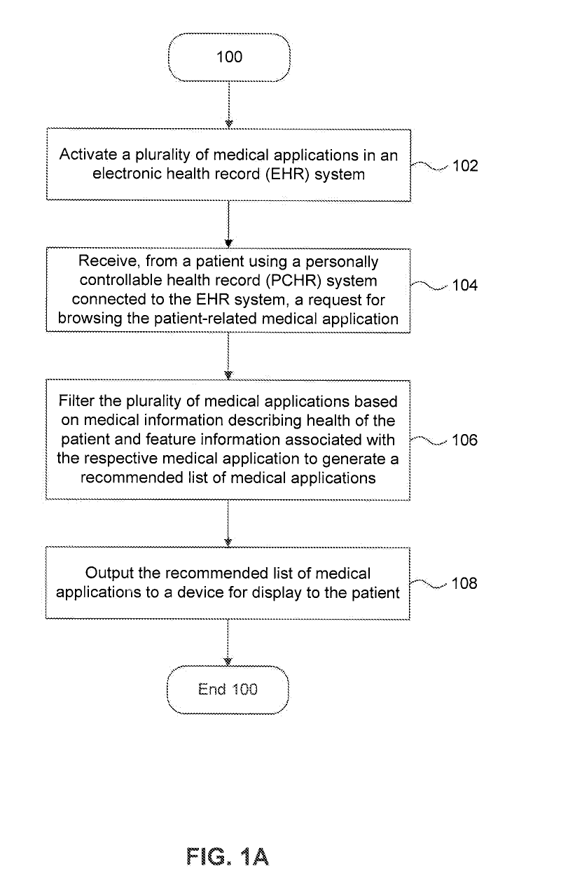

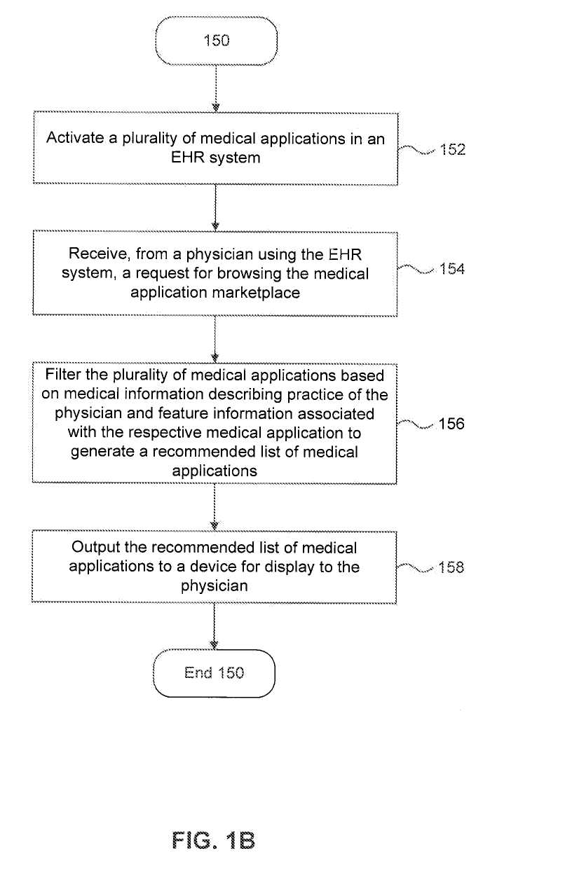

FIG. 1A is a flowchart illustrating a method 100 to provide a patient-related medical application marketplace. The presentation of the marketplace is specifically tailored to the medical information associated with the patient.

Method 100 begins at step 102 by activating a plurality of medical applications in the EHR system. A medical application can be a software medical application or a hardware medical device. A software medical application in the patient-related medical application marketplace can be used by a patient. For example, a patient diagnosed with diabetes can use a web-based diabetes tracking software to track blood sugar level and medication usage. An example of a hardware medical device for a patient is a vital signs monitor that automatically measures a patient's non-invasive blood pressure (NIBP), pulse rate, temperature, and pulse oximetry every 30 seconds. A medical application can also be a gateway to a third party service provider such as a company running clinical laboratory tests.

The activation of step 102 is the first step to integrate medical applications into the patient-related medical application marketplace in an EHR system. In one embodiment, the vendor of a medical application enters a serial number and a machine fingerprint of the medical application into the EHR system to generate an activation key. Then the EHR system can activate the medical application. Along with the activation, information related to the medical application is stored in the database. The information related to the medical application can include, but are not limited to, the description of the medical application, the purchasing method of the medical application (e.g., a link to a purchase web page, or a link for downloading a software medical application), functionalities of the medical application, and types of medical problems that the application helps to treat. The EHR system may process the information related to the activated medical application to generate one or more keyword tags for the medical applications. Those keyword tags describe the categories and features of a medical application and help the EHR system to find the medical application again by browsing or searching. The EHR system may store the keyword tags in the database.

The EHR system may alternatively process the information related to the activated medical application to generate one or more codes for the medical applications. Those codes correspond the categories and features of the medical application. The EHR system may use the codes to find the medical application even more efficiently. One example of the codes is the SNOMED CT codes. SNOMED CT (Systematized Nomenclature of Medicine Clinical Terms) is a systematically organized collection of medical terms. SNOMED CT provides codes, terms, synonyms and definitions used in clinical documentation and reporting. Clinical terms in the SNOMED CT format are computer processable and they provide a standardized way to represent clinical phrases captured by the health practitioners and enable automatic interpretation of these clinical phrases. For instance, the SNOMED CT code representing diabetes is 73211009. After the EHR system activates a software application that helps treating diabetes, the EHR system may store SNOMED CT code 73211009 as a part of the information related to the software application. Another example of the codes is the International Classification of Diseases (ICD) codes. For instance, the ICD-9 code representing diabetes is 250. The EHR system may store 250 as a part of the information related to the software application that helps diabetes treatment.

If the medical application is a software application, the EHR system not only stores information related to the software application but may also store the software application itself so that a patient can directly download the software application from the EHR system. In other embodiments, the EHR system includes a web server for displaying EHR records to a user and helping the user to manage EHR records. If the medical application is a web-based software application, the EHR system can further integrate the web-based medical application into the web server, and the web-based medical application becomes a component of the web server in the EHR system.

Once the EHR system is set up with activated medical applications, a patient can log into a PCHR system connected to the EHR system. The patient may then request to browse through medical applications in the patient-related medical application marketplace at step 104. In one example, the request is transmitted as a hypertext transfer protocol (HTTP) request. After the EHR system receives the request to browse the patient-related medical application marketplace, the EHR system can present medical applications in the marketplace tailored to the patients' specific medical situations.

As mentioned above, making a patient browse through all of the applications stored in the database is burdensome. The patient does not need to see all medical applications activated in the EHR system because only a small portion of the medical applications available are relevant to the patient. Thus, the list of medical applications presented to the patient need to be narrowed down. To that end, the EHR system generates a recommended list of medical applications tailored to the medical situations of the patient. The EHR system may filter medical applications stored in the database to generate a recommended list of medical applications at step 106. The filtering of medical applications can be based on medical information describing health of the patient and feature information associated with the medical applications. One advantage of the EHR system performing the filtering step comes from the benefit of integration because medical information associated with the patient and feature information associated with the medical applications are already stored in the database of the EHR system. With this integration benefit, no extra operations or human effort are required for collecting the medical information and the feature information at the filtering step.

To filter a medical application, the EHR system may determine a match between the medical information describing health of the patient and feature information of the medical application. If there is a match, the medical application is included in the recommended list. In one embodiment, the match can be an exact match. For example, the medical information associated with the patient can indicate that the patient is diagnosed with diabetes. The feature information of a glucose tracking software application indicates that the application has a keyword tag of “diabetes.” Because of the exact match of the word “diabetes” in the medical information of the patient and the feature information of the medical application, the glucose tracking software application is added to the recommended list. If the EHR system stores codes (e.g., ICD9 or SNOMED CT) for feature information of a medical application, the EHR system may alternatively determine a match based on whether the code representing patient's medical condition (e.g., SNOMED CT code 73211009 for diabetes) matches feature information associated with a medical application of the plurality of medical applications.

Medical applications in method 100 are used mainly by patients. Some medical applications might require prescription before a patient can purchase or download the medical applications. The EHR system may not want to present these prescription medical applications to a patient in the patient-related medical application marketplace. Thus, the EHR system may further limit the filtering step 106 by ensuring that the recommended list of medical applications include only medical applications that do not require prescription. For example, the EHR system may first exclude prescription medical applications before generating the recommended list of medical applications.

In another embodiment, relevancy between feature information of the medical application and the medical information of patient determines the match. For example, the EHR system can calculate a relevancy score between the feature information and the medical information. If the relevancy score is above a threshold value, then the medical application can be added to the recommended list.

To further assist the patient in browsing and choosing medical applications, the medical applications on the recommended list can be ordered by importance. Medical applications more important to the patient are displayed before the less important medical applications. The EHR system may determine the order of the medical applications on the recommended list based on various factors. For example, the EHR system can determine the order based on the relevance scores between medical applications and the medical information of the patient. The EHR system can also use other factors to help determine the order of medical applications on the recommended list.

As described, when a patient logs into the PCHR system connected to the EHR system and browses the patient-related medical application marketplace, the EHR system filters the medical applications based on the medical information associated with the patient. The medical information associated with the patient comes from the PCHR of the patient. The EHR system can compare the feature information of the medical application to the medical information associated with the patient to determine whether there is a match. In one embodiment, the EHR system compares the feature information of the medical application to the patient's health condition such as diagnosed medical problems. In other embodiments, the EHR system compares the feature information of the medical application to other medical information of the patient, such as lab test results, and medication profile of the patient. In addition, the EHR system may compare the feature information of the medical application to age or gender of the patient.

Once the recommended list of medical applications is generated, the EHR system outputs the recommended list to a client device for display to the patient at step 108. In one embodiment, the recommended list may be output by transmitting the data describing the list of medical applications over a network to the client device. The recommended list of medical applications may be formatted, for example, as a part of a hypertext markup language (HTML) file, and may be transmitted to the client device using web protocols such as HTTP. In this way, the recommended list of applications may be displayed using a conventional web browser. This is only an example; a skilled artisan would recognize that other protocols and devices may be used to effect outputting the recommended list to a display.

FIG. 1B is a flowchart illustrating a method 150 for providing a physician-related medical application marketplace. According to an embodiment, the presentation of the physician-related marketplace is specifically tailored to medical information describing practice of the physician.

Method 150 begins at step 152 by activating a plurality of medical applications in the EHR system. Step 152 encompasses all the features of step 102 of method 100 in FIG. 1A. A software medical application in the physician-related medical application marketplace can be a patient-related application that the physician can prescribe or recommend to patients. On the other hand, in contrast to a patient-related medical application marketplace, a physician-related medical application marketplace can present both prescription and non-prescription medical applications to physician users. In addition, medical applications presented to a physician may include practice productivity applications that the physician can use. Practice productivity applications are software applications that help physicians to be more productive and effective in the running of their medical practices. For example, a physician may use an appointment reminder software application to manage appointment scheduling for the physician's patients. Other examples of practice productivity applications include, but not limited to, dictation software applications that help physician to capture voice transcription of encounters, compliance software applications that assist physicians in compliance-related tasks, and vaccine management software applications that can remind physicians when the vaccine inventory is low.

Once the EHR system is set up with activated medical applications, a physician can log into the EHR system and request to browse through medical applications in the physician-related medical application marketplace at step 154. In one example, the request is transmitted as a hypertext transfer protocol (HTTP) request. After the EHR system receives the request to browse the physician-related medical application marketplace at step 154, the EHR system can present medical applications in the physician-related marketplace tailored to the physician's specific practice.

As mentioned above, making a physician to browse through all of the applications stored in the database is burdensome. The physician does not need to see all medical applications activated in the EHR system because only a small portion of the medical applications available are relevant to the physician's need. Thus, the list of medical applications presented to the physician need to be narrowed down. To that end, the EHR system generates a recommended list of medical applications tailored to medical information describing practice of the physician. The EHR system may filter medical applications stored in the database to generate a recommended list of medical applications at step 156. The filtering of medical applications can be based on medical information describing practice of the physician and feature information associated with the medical applications. One advantage of the EHR system performing the filtering step comes from the benefit of integration because medical information associated with the physician and feature information associated with the medical applications are already stored in the database of the EHR system. With this integration benefit, no extra operations or human effort are required for collecting the medical information and the feature information at the filtering step.

To filter the medical application, the EHR system may determine a match between the medical information describing the practice of the physician and feature information of the medical application. If there is a match, the medical application is included in the recommended list. In one embodiment, the match can be an exact match. For example, the medical information associated with a physician can indicate that the physician treats patients diagnosed with diabetes. The feature information of a glucose tracking software application indicates that the application has a keyword tag of “diabetes” (or an ICD-9 or SNOMED CT code representing diabetes). Because of the exact match of the key “diabetes” in the medical information of physician and the feature information of the medical application, the glucose tracking software application is added to the recommended list. In another embodiment, relevancy between feature information of the medical application and the medical information of the physician determines the match. For example, the EHR system can calculate a relevancy score between the feature information and the medical information. If the relevancy score is above a threshold value, then the medical application can be added to the recommended list.

To further assist the physician in browsing and choosing medical applications, the medical applications on the recommended list can be ordered by importance. Medical applications more important to the user are displayed before the less important medical applications. The EHR system determines the order of the medical applications on the recommended list based on various factors. For example, the EHR system can determine the order based on the relevance scores between medical applications and the medical information of the physician. The EHR system can also use other factors to help determine the order of medical applications on the recommended list.

When the physician logs into the EHR system and requests to browse the medical application marketplace, the EHR system filters the medical applications based on the medical information associated with the physician's practice. In some embodiments, the EHR system stores information related to the physician's specialty in the database. To serve a request from the physician to browse the physician-related medical application marketplace, the EHR system compares the physician's practice specialty to the feature information of a medical application. If there is a match, the medical application is added to the recommended list. As described above, in some embodiments, the EHR system can also rank the medical applications on the recommended list. The ranking depends on a variety of factors. In one embodiment, feature information of a medical application includes a type of a medical problem that the medical application helps to treat. In this embodiment, the number of the physician's patients diagnosed with the medical problem affects the ranking of the medical application. For example, a physician may treat 200 patients diagnosed with diabetes and also treat 10 patients diagnosed with atherosclerosis. Thus, a medical application associated with the treatment of diabetes may rank higher than another medical application associated with the treatment of atherosclerosis for the physician.

Once the recommended list of medical applications is generated, the EHR system outputs the recommended list to a client device for display to the physician at step 158. In one embodiment, the recommended list may be output by transmitting the data describing the list of medical applications over a network to the client device. The recommended list of medical applications may be formatted, for example, as a part of a hypertext markup language (HTML) file, and may be transmitted to the client device using web protocols such as HTTP. In this way, the recommended list of applications may be displayed using a conventional web browser. This is only an example; a skilled artisan would recognize that other protocols and devices may be used to effect outputting the recommended list to a display.

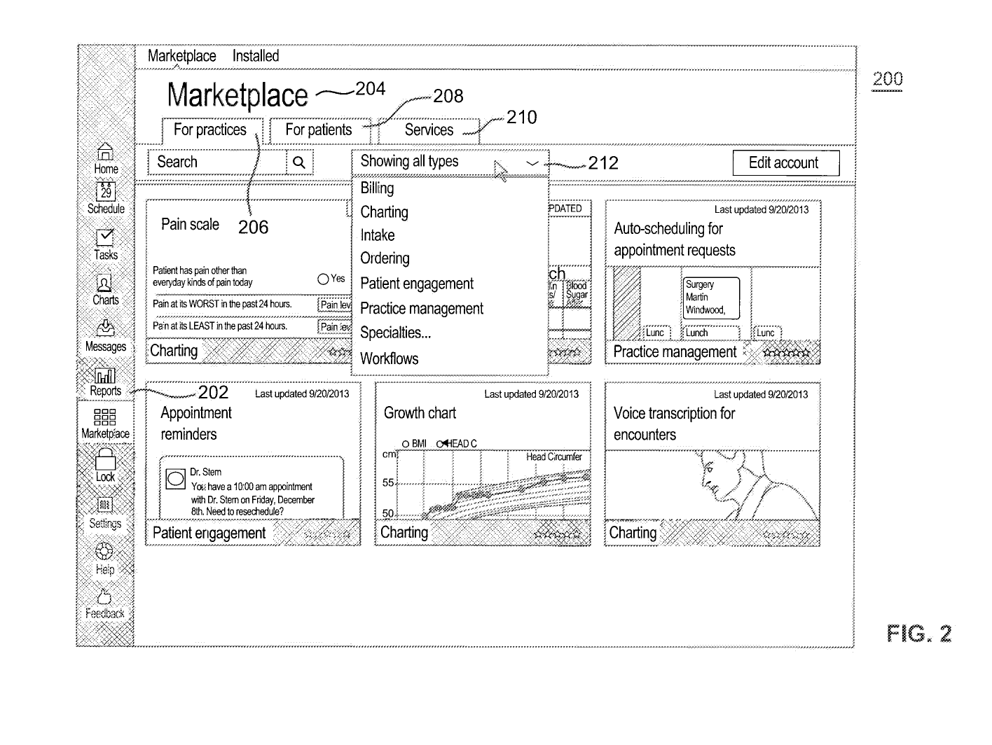

FIG. 2 shows a screen 200 illustrating a user interface that displays a recommended list of medical applications in a physician-related marketplace, according to some embodiments. Screen 200 may be the result of the outputting step 158 in FIG. 1B. The user interface for a physician-related medical application marketplace may be a part of a native client application connected to the EHR system. The marketplace interface may also be a part of a web application in a web browser acting as a client that sends HTTP requests to and receives HTTP responses from a web server in the EHR system.

Once a physician logs into the EHR system, the physician can request to browse the medical application marketplace by clicking on marketplace icon 202. After the EHR system outputs the recommended list of medical applications to the client device, the medical applications in the list are displayed in marketplace section 204. In one embodiment, the marketplace interface may display all medical applications relevant to the physician. In another embodiment, the marketplace interface may display medical applications relevant to the physician by categories. For example, if the physician user clicks on the “for practice” tab 206, the marketplace interface displays medical applications related to the physician's practice (e.g., practice productivity applications). If the physician clicks on “for patients” tab 208, the marketplace interface displays medical applications related to the physician's patients. If the physician clicks on “services” tab 210, the marketplace interface displays services, such as services for laboratory tests from third party service providers. In one embodiment, a separate request for each category is sent for browsing medical applications within the category, when the physician clicks on the tab associated with the category. In another embodiment, a single request is sent for browsing medical applications in the physician-related marketplace, and the client device can separate the medical applications on the recommended list into different tabs according to these medical applications' categories.

To further help the physician to browse through the medical applications relevant to the physician, in some embodiments, the medical applications on the recommended list are displayed in the order specified by the recommended list. Thus, if the EHR system ranks the medical applications on the recommended list, the marketplace interface displays the medical applications as ranked by the EHR system. In this way, the physician can find medical applications most relevant to the user more easily. Additionally, the marketplace interface may further narrow the displayed medical applications by types of the medical applications. For example, the physician may choose a type in dropdown list 212, and the marketplace interface would then only display medical applications of the chosen type selected from dropdown list 212.

In this way, embodiments provide an easy-to-use interface for a physician to efficiently browse a physician-related medical application marketplace and find medical applications most relevant to the physician user from many available medical applications activated in the EHR system. The ease of use and the efficiency come from the integration benefit of utilizing medical information associated with the physician and feature information associated with the medical applications, both of which have already been stored in the database of the EHR system. A person of skill in the art would understand that modifications may be made to the interface while staying within the spirit and scope of the present invention.

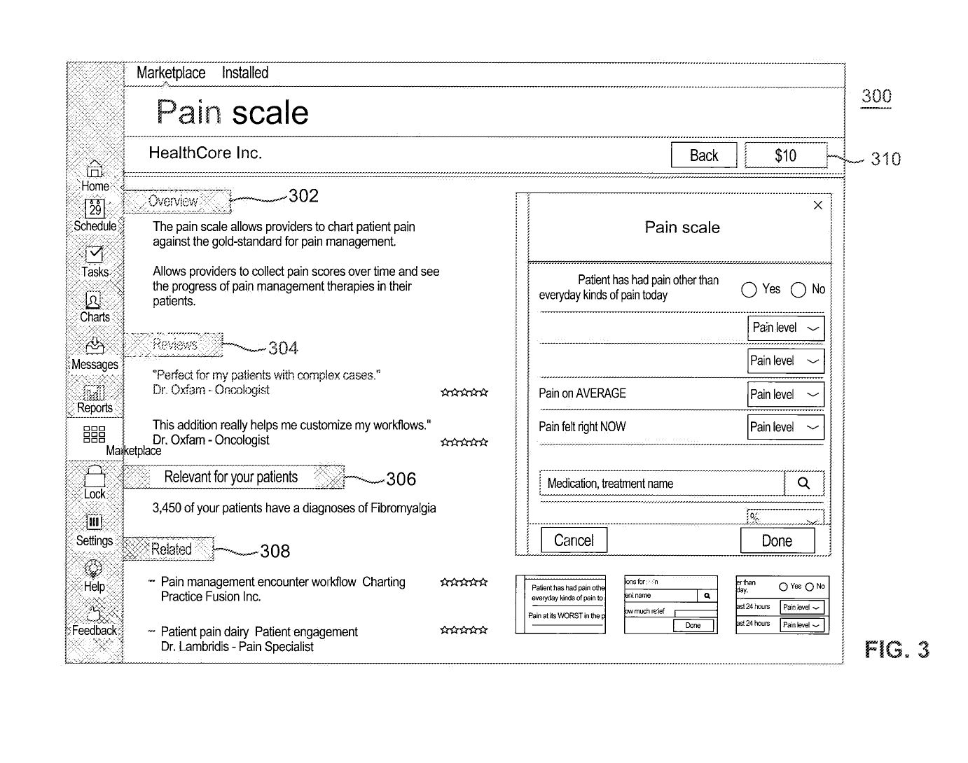

When the physician has identified a medical application that the physician is interested in, the physician may select the medical application. The medical application may be selected, for example, by clicking on the displayed medical application with a mouse, by touching the displayed medical application on a touchscreen using a finger, stylus, and the like, by keystroke on a keyboard, etc. Upon selection, another view may appear that presents additional details about the medical application. FIG. 3 shows an exemplary screen 300 that displays additional details of a medical application selected by the physician user. In one embodiment, screen 300 displays an overview of the medical application in area 302. Reviews about the medical application are presented in area 304. Area 306 may provide information of the medical application relevant to the physician's patients. The relevant information may include a medical problem that the medical application helps to treat and the number of the physician's patients diagnosed with the medical problem. Screen 300 may include area 308 for displaying related medical applications. The related medical applications often work in conjunction with the selected medical application displayed in screen 300. For example, the physician might have selected to view a pain scale medical application for charting purpose. Screen 300 can display a patient pain diary medical application for patient engagement purpose in area 308. The related medical applications can also be applications that provide similar functionalities to the selected medical application for the physician to compare and make an informed purchasing decision.

Screen 300 can also provide a link for the physician user to purchase or download the selected medical application. For example, screen 300 may display the price of the selected medical application in purchase button 310. If the physician decides to buy the selected medical application after reviewing the details provided by screen 300, the physician initiates the purchase by clicking purchase button 310.

The marketplace interface may also provide an option for the physician to mark a medical application as favorite. For example, if the physician decides not to purchase or download the selected medical application at the moment but is still interested in the medical application, the marketplace interface may present an option for the physician to mark the selected medical application as favorite, and the physician can retrieve the application marked as favorite quickly later on. In another example, if a physician purchases or downloads a medical application and decides that the medical application could be helpful to many of the physician's patients, the physician may mark the medical application as favorite so that the physician can later recommend or prescribe the medical application to many of his patients.

The embodiments in FIGS. 2 and 3 provide user interfaces for a physician-related marketplace. One skilled in the art would recognize that interfaces for a patient-related marketplace can employ similar features and functionalities disclosed in embodiments in FIGS. 2 and 3. A person of skill in the art would understand that modifications may be made to the interfaces while staying within the spirit and scope of the features and functionalities disclosed in FIGS. 2 and 3.

The integration of the EHR system with a patient-related medical application marketplace may continue even after the patient user purchases or downloads a medical application. In addition to providing information of medical applications relevant to the patient, the EHR system can receive medical data collected by the medical application after the purchase or the download. In one embodiment, after the patient finishes purchasing or downloading a selected medical application, the EHR system will receive a notification about the purchase or download. The EHR system may store the information about the purchase of download and medical data collected by the medical application in the database of the EHR system. In one embodiment, if the collected medical data is medical data of a patient, the medical data may be stored as a part of the patient's PCHR. For example, after a patient purchases or downloads a pain recording software application through the patient-related medical application marketplace, the patient starts to use the pain recording software to collect pain level data felt by the patient. The purchase or download information and the pain level data are sent to the EHR system for storage. Later, when the patient's physician logs into the EHR system, the physician can see the most recent update regarding the pain levels recorded by the patient and make adjustment in treatment accordingly.

There are various embodiments for transmitting medical data collected by a medical application to the EHR system. If the purchased or downloaded medical application is a web-based application that has been integrated into the web server of the EHR system, the web-based application may collect data and send the data to the EHR system through the web server. If the purchased or downloaded application is a native software application or a medical device with network connectivity, the collected data may be sent to the EHR system directly. In another embodiment, the purchased or downloaded medical application may send the collected data through another device. For example, a medical device for measuring glucose levels may transmit measured glucose level data to a mobile device via a Bluetooth connection, and the mobile device could relay the glucose level data to the EHR system for storage. Other methods of transmitting medical data to the EHR system would be evident to a skilled artisan.

### Medical Application Prescription

Many medical applications improve quality of the treatment for patients. Similar to the physician's prescription of medications to a patient, sometimes a physician may consider a medical application so important to the treatment to one of his patients that the physician wants to prescribe the medical application to the patient. Conventionally, if the physician feels that it is necessary for the patient to purchase, download and use a medical application, the physician might just ask the patient to buy the medical application in the conversation during an office visit between physician and the patient. Such conventional ways of “prescribing” medical applications often are inconvenient and ineffective. For example, during a typical encounter between the physician and the patient (e.g., an office visit), the physician needs to go through the patient's health record, diagnose the medical problem of the patient, and make a mental search of medical applications that the physician knows of. When the physician remembers a medical application suitable for the patient's medical problem, there are also possibilities of miscommunication. For instance, there might be multiple medical applications with “Glucose Monitor” in their names, and the patient might purchase or download an application named “Glucose Monitor” that is different from the one that the physician wants. Also, the patient might forget to buy the prescribed medical application after the meeting with the physician. More seriously, in a subsequent encounter, the physician might not remember that the physician has asked the patient to buy a medical application during the previous encounter and miss the opportunity to double check with the patient about the result of the prescription.

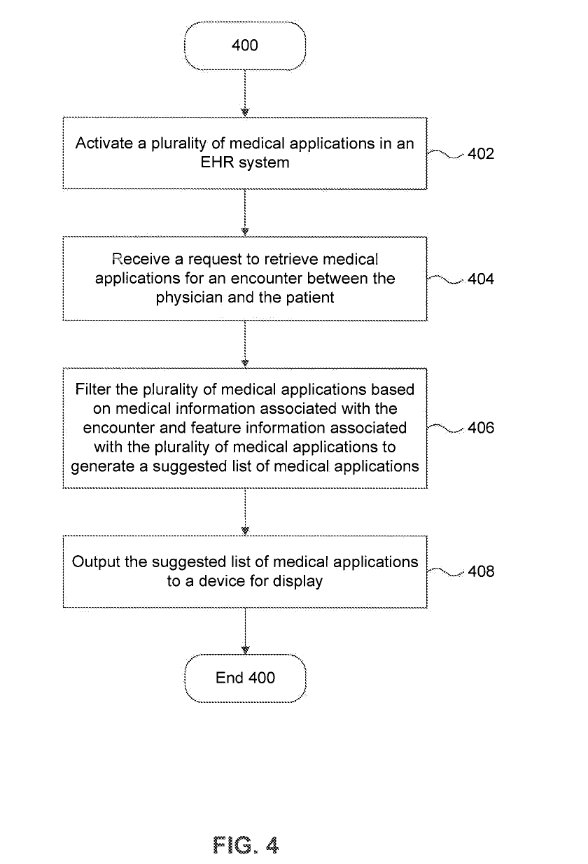

Again, the integration of medical applications with the EHR system can help solve the issues described above and even provide additional benefits. FIG. 4 is a flowchart illustrating a method 400 for a physician to prescribe a medical application to a patient during an encounter between the physician and the patient. The EHR system may present the medical application prescription in an output screen for the encounter. The presentation of medical application prescription can be specifically tailored to the medical information associated with the encounter.

Method 400 begins at step 402 by activating a plurality of medical applications in the EHR system. Step 402 encompasses all the features of step 102 of method 100 in FIG. 1A. As described, a medical application can be a software medical application or a hardware medical device. Medical applications in method 400 are used mainly by patients. As described, the EHR system may store feature information related to the medical applications as a part of the activation process. In addition, the EHR system may store additional information related to medical applications that provides better matching between the medical applications and a physician-patient encounter. The physician-patient encounter may be an office visit by the patient. In some embodiments, the EHR system generates and stores one or more tags describing functionalities for each activated medical application.

During a physician-patient encounter, the physician logs into the EHR system to read the record related to the encounter. In some embodiments, the request is sent to the EHR system after the physician inputs additional medical information acquired during the encounter. For example, during an encounter, after the physician diagnosed the patient with diabetes and inputs the diagnosis information into the record related to the encounter, the EHR system then receives the request to retrieve medical applications related to the encounter at step 404. With additional medical information the physician inputs during the encounter, the EHR system can make better decisions to find matching medical applications for prescription. In one embodiment, the request received by the EHR system may include the additional medical information (e.g., diagnosis) inputted by the physician. In another embodiment, the additional information the physician inputs is saved in the database of the EHR system first, and the request would trigger the EHR system to retrieve the additional medical information stored in the database.

As discussed, the EHR might store a huge number of activated medical applications in its database. In addition, the physician has limited time to browse through all available medical applications to determine the best medical applications suitable to the purpose of the encounter. Thus, sometimes the list of medical applications presented to the physician needs to be narrowed down even more than the marketplace. To that end, the EHR system generates a suggested list of medical applications tailored to the physician-patient encounter. In some embodiments, the EHR system filters activated medical applications in the database to generate the suggested list of medical applications at step 406. The filtering of medical applications can be based on medical information associated with the encounter and feature information associated the medical applications. Similar to the medical application marketplace feature, one advantage of the EHR system performing the filtering step is the benefit of integration because medical information associated with the physician-patient encounter and feature information associated with the medical applications are readily available to the EHR system either in the database of the EHR system or in the request received by the EHR system. With this integration benefit, there are no extra operations or human effort required for collecting the medical information and the feature information at the filtering step, and the EHR system can easily retrieve the information necessary to help the EHR system find matching medical applications.

Similar to the marketplace feature, in some embodiments, the EHR system filters the medical applications by determining a match between the medical information associated with the encounter and feature information of a medical application. If there is a match, the medical application is included on the suggested list. In one embodiment, the match can be an exact match. For example, the medical information indicates that the physician has diagnosed the patient of hypertension during an encounter, and the feature information of a blood pressure tracking software application indicates that the application has a keyword tag of “hypertension” or is associated with a code that represents hypertension. Because of the exact match of the word “hypertension” in the medical information of the encounter and the feature information of the medical application, the blood pressure tracking software application is added to the suggested list. In another embodiment, relevancy between feature information of the medical application and the medical information of the encounter determines the match. For example, the EHR system can calculate a relevancy score between the feature information and the medical information. In some embodiments, the EHR system calculates a relevancy score based on a relevancy score between the medical problem for the encounter and the set of tags of the medical application. If the relevancy score is above a threshold value, then the medical application can be added to the suggested list.

A physician usually has limited time to find a suitable medical application for prescription during the encounter with the patient. Thus, the physician may want to spend far less time in prescribing a medical application than a typical user would spend in purchasing a medical application in the marketplace. To further assist the physician in finding a medical application for prescription, the number of medical applications on the suggested list often needs to be smaller than the number of medical applications presented in the marketplace. In one embodiment, the threshold value for including a medical application on the suggested list of applications may be higher than the threshold value for presenting the marketplace. In another embodiment, the suggested list may have a limitation to the size of the suggested list. For example, the EHR system may only add 5 medical applications with top 5 highest relevancy scores to the suggested list. To save the physician's time, medical applications on the suggested list may be ordered according to the applications importance. In some embodiments, the importance is ranked based on relevancy scores. Consequently, the medical applications on the suggested list can be displayed in the order specified by the suggested list so that the more important medical applications are displayed before the less important medical applications.

Once the suggested list of medical applications is generated, the EHR system outputs the suggested list to a client device for display to the physician at step 408. In one embodiment, the suggested list may be output by transmitting the data over a network to the user device. The suggested list of medical applications may be formatted, for example, as a hypertext markup language (HTML) file, and may be transmitted to the user device using web protocols such as HTTP. In this way, the suggested list of applications may be displayed using a conventional web browser. In one embodiment, the suggested list of medical applications is displayed as a part of a web page showing information associated with the physician-patient encounter. This is only an example; a skilled artisan would recognize that other protocols and devices may be used to effect outputting the suggested list to a display.

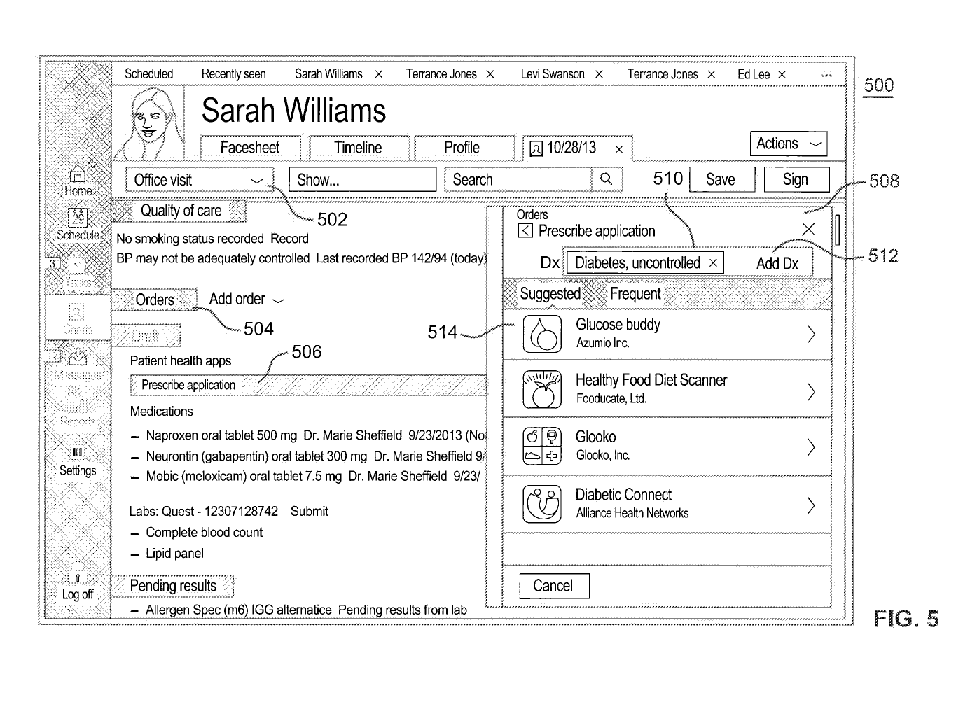

FIG. 5 shows a screen 500 illustrating a prescription interface that displays a suggested list of medical applications. Screen 500 may be the result of the outputting step 408 in FIG. 4, according to some embodiments. In one embodiment, the display of the suggested list of medical applications is embedded in an output screen showing a record related to the physician-patient encounter.

Once the physician opens the encounter record in the EHR system, the physician can view information related to the encounter. For example, dropdown list 502 shows that the type of the encounter is an office visit. Area 504 displays orders that the physician prescribes to the patient. The orders can include medication orders and laboratory test requests. The orders also include medical application prescriptions. When the physician decides to prescribe a medical application to the patient, the physician initiates the prescription by selecting text area 506. Text area 506 may be selected, for example, by clicking on the displayed the text area with a mouse, by touching the text area on a touchscreen using a finger, stylus, and the like, by keystroke on a keyboard, or by simply hovering the mouse over the text area, etc. Selecting text area 506 may cause application prescription sub-window 508 to pop up. Prescription sub-window 508 contains text field 510. The physician can input additional medical information acquired during the encounter. For example, after the physician diagnoses the patient of a new medical problem during the encounter, the physician can input the new diagnosis in text field 510. In one embodiment, text field 510 is automatically populated with a previously diagnosed medical problem stored in the database of the EHR system, but text field 510 is editable by the physician. In another embodiment, the physician can add additional diagnoses by clicking on label 512.

In some embodiments, inputting additional medical information associated with the encounter in text field 510 causes the request to retrieve medical applications for the encounter to be sent to the EHR system. In some embodiments, the request received by the EHR system may include the additional medical information (e.g., diagnosis) inputted by the physician. In another embodiment, the additional medical information inputted by the physician is saved in the database of the EHR system first, and the request would trigger the EHR system to retrieve the additional medical information stored in the database.

Once the EHR system outputs the suggested list of medical applications in area 514, the physician can select one medical application on the suggested list to prescribe to the patient. In one embodiment, the physician completes the prescription by one click of the selected medical application. In another embodiment, clicking the selected medical application leads to a second output screen, in which the physician can enter additional information about the prescription before completing the prescription.

In this way, embodiments provide a convenient interface for the physician, to efficiently find and prescribe a medical application to the patient. The convenience and the efficiency come from the integration benefit of utilizing medical information associated with the encounter and feature information associated with the medical applications already stored in the database of the EHR system. In addition, the EHR knows how to send the prescription to the patient because the patient's contact information is already stored in the EHR system. A person of skill in the art would understand that modifications may be made to the interface while staying within the spirit and scope of the present invention.

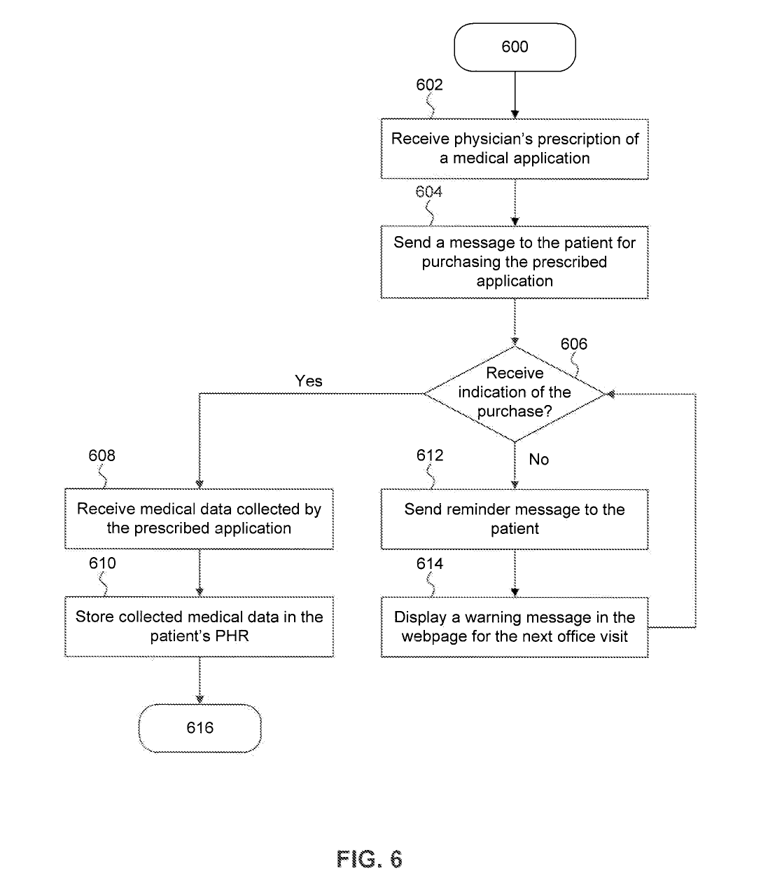

The integration of the EHR system with medical application prescription extends beyond providing a convenient way for the physician to prescribe a medical application to the patient. Similar to prescription of medications, one important aspect of the prescription of medical applications is to make sure that the patient actually purchases or downloads and uses the prescribed medical application. FIG. 6 is a flowchart illustrating a method 600 for ensuring that the patient has purchased or downloaded the prescribed medical application and monitoring the patient's usage of the prescribed medical application, according to some embodiments.

Method 600 begins at step 602 when the EHR system receives the physician's prescription of a medical application. The EHR system receives the prescription as the result of the physician selecting a medical application for prescription, as described in FIG. 5. The EHR system may store the received prescription of the medical application. In one embodiment, the EHR system stores the received prescription of the medical application in the patient's PHR. At step 604, The EHR system sends a message to inform the patient to purchase or download the prescribed medical application. The message may contain information about how to purchase or download the prescribed medical application. In one embodiment, the message includes a link which the patient can follow in order to purchase or download the prescribed medical application. The message may be sent to the patient via email if the EHR system stores the patient's email address as a part of the patient's PHR. A person skilled in the art would appreciate that other means of sending the message for the purchase or download are available. For example, the EHR system might send the message to the patient's mobile device via SMS. In another example, the patient may see a popup message, with a link helping the patient to purchase or download the prescribed medical application, in a web browser when the patient logs into the EHR system.

To ensure that the patient follows the physician's prescription of the medical application, the EHR systems keeps checking the status of the patient's purchase or download periodically at step 606. If the EHR system receives an indication that the patient has purchased or downloaded the prescribed medical application, then method 600 proceeds to step 608.

At step 608, the EHR system may store the indication about the purchase or download. With the reception of the purchase or download indication, the EHR system can stop the periodical check of the patient's purchase status. In addition, the purchase or download information may be stored as a part of the patient's PHR. This is helpful because the physician can see what prescribed medical applications the patient has purchased or downloaded in a follow-up encounter.

The EHR system may also store medical data collected by the prescribed medical application in the database of the EHR system. In one embodiment, medical data collected by the prescribed medical application is stored as a part of the patient's PCHR and flows to the physician's EHR for viewing, trending, and deciding what to do next for that patient. In this way, the physician can see that the patient not only has purchased or downloaded the medical application but also keeps using the application. In addition, the physician may read collected data about the patient's health status and make treatment adjustment accordingly. As described, there are various embodiments for transmitting medical data collected by a medical application to the EHR system. If the prescribed medical application is a web-based application that has been integrated into the web server of the EHR system, the web-based application may collect medical data and send the data to the EHR system through the web server. If the purchased or downloaded application is a native software application or a medical device with network connectivity, the collected data may be sent to the EHR system directly. In another embodiment, the purchased or downloaded medical application may send the collected data through another device. For example, a medical device for measuring glucose levels may transmit measured glucose level data to a mobile device via a Bluetooth connection, and the mobile device would relay the glucose level data to the EHR system for storage. Other methods of transmitting medical data to the EHR system would be evident to a skilled artisan.

At step 610, the EHR system stores the collected medical data in its database. In one embodiment, the EHR system integrates medical data collected by the prescribed medical application into the PCHR associated with the patient. In this way, the physician can view the most updated medical data of the patient and make timely treatment adjustment decisions accordingly.

If the EHR system does not receive any indication that the patient has purchased or downloaded the prescribed medical application within a predefined time period, the EHR system may take multiple measures to ensure that the patient follows the physician's prescription of the medical application. For example, at step 612, the EHR system may send reminder messages to the patient. The EHR system message may send the reminder message to the patient via email if the EHR system stores the patient's email address in the patient's PHR. A person skilled in the art would appreciate that other means of sending the message for purchase or download are available. For example, the EHR system might send the message to the patient's mobile device via SMS. In another example, the patient may see a popup message when the patient logs in to the PCHR system. Additionally, at step 614, the EHR system can send warning messages to the physician to help enforce the physician's prescription of medical applications. In one example embodiment, during a follow-up office visit, the physician can see a warning message displayed in a web page for the follow-up office visit such as the one illustrated in FIG. 4. The warning message informs the physician that the patient has not purchased or downloaded the prescribed medical application, and the physician may discuss the issue with the patient in person during the follow-up office visit. If the patient still forgets to purchase or download the prescribed medical application after the follow-up meeting with the physician, then method 600 repeats steps 606-614. In one embodiment, the EHR checks the reception of the purchase or download indication periodically, and keeps sending reminder messages to the patient and warning messages to the physician until the patient follows the prescription.

### System

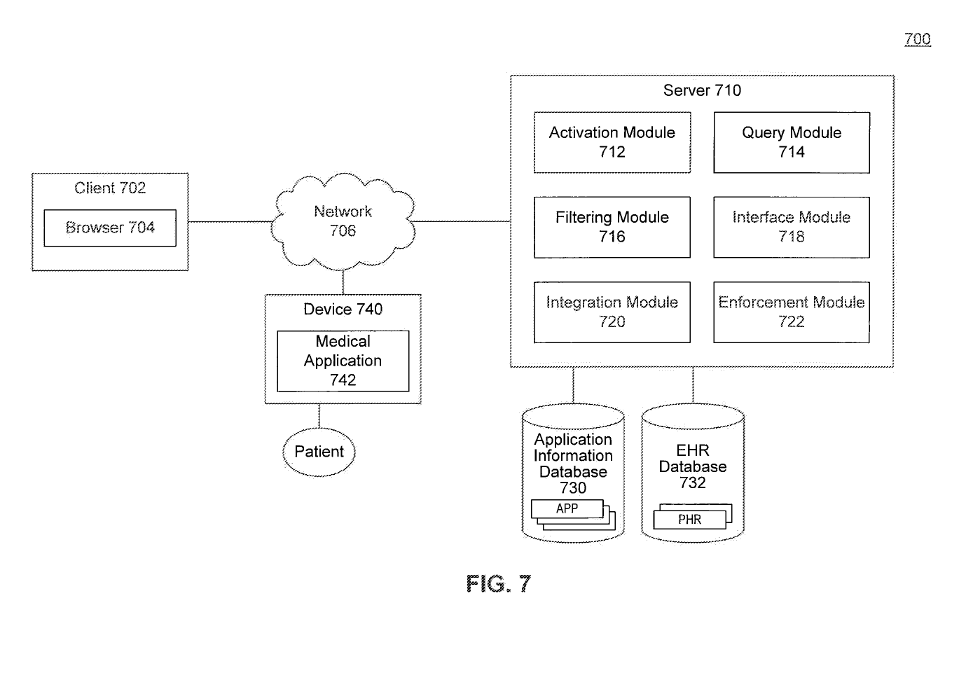

FIG. 7 is a diagram illustrating an example system 700 for providing medical application marketplaces and for helping a physician to prescribe medical applications to patients during physician-patient encounters. System 700 includes a client 702 and server 710 connected by one or more networks 706, such as the Internet. Server 710 is also coupled to one or more databases. Server 710 may be part of a comprehensive EHR system, as described in further detail below.

Client 702 may, for example, include web browser 704 that enables a user (e.g., a patient or a physician) to browse through an EHR system. For example, the patient user can use web browser 704 to log into a PCHR system connected to the EHR system and navigate through a patient-related medical application marketplace. Similarly, a physician user can use web browser 704 to log into the EHR system and navigate through a physician-related medical application marketplace. The physician user can use web browser 704 to prescribe a medical application to the physician's patient during a physician-patient encounter. The web browser responds to user input, such as user selection of different portions of an interface, by sending an HTTP request to server 710 via network 706. In another example, the user may interface with client 702 through a native application instead of a web browser, such that the native application communicates with server 710. Client 702 may be any type of computing device, such as and without limitation, a PC, laptop, or mobile device.

To respond to the request from client 702, server 710 may operate as described above for FIGS. 1A, 1B, 4, and 6. In the embodiment of FIG. 7, server 710 includes six modules: activation module 712, query module 714, filtering module 716, interface module 718, integration module 720, and enforcement module 722. Each module is described below in turn.

Activation module 712 receives activation keys from vendors of medical applications. Once activation module 712 verifies an activation key for a medical application, activation module 712 can store information related to the medical application in application information database 730. Information related to the activated medical application includes, but not limited to, feature information associated with the medical application describing the medical application's functionalities. Feature information associated with a medical application may be stored in application information database 730 in the form of tags or codes such as ICD codes or SNOMED CT codes. In some embodiments, if the medical application is a software application, the software application itself may be stored in the application information database as well.

Query module 714 receives a request from client 702. The request may be a request for browsing a patient-related medical application marketplace from a patient or a request for browsing a physician-related medical application marketplace from a physician. The request may also be a request for querying possible medical application for prescription. Query module 714 then forwards the request to filtering module 716. Query module 714 can also receive a request related to a physician prescription of a medical application to a patient and forward the prescription request to integration module 720 for further processing.

Application information database 730 may store information about a large number of medical applications. It may be too cumbersome for a user to go through all medical applications activated in the EHR system. Filtering module 716 is responsible for narrowing down the number of medical applications presented to the user. Filtering module 716 utilizes information stored in application information database 730 and EHR database 732 to narrow down the number of medical applications. EHR database 732 stores a plurality of different types of patients' medical records. EHR database 732 may store medical records related to patients, such as PCHRs. EHR database 732 may store practice information related to physicians. Event-based medical records, such as records associated with physician-patient encounters can also be stored in EHR database 732. EHR database 732 and application information database 730 may be any type of structured data store, including a relational database. FIG. 7 shows that EHR database 732 and application information database 730 reside on two separate database platforms. In other embodiments, EHR database 732 and application information database 730 may reside on the same database platform.

If the request forwarded to filtering module 716 is for browsing a medical application marketplace, filtering module 716 filters medical applications based on medical information associated with the user and feature information associated with medical applications to generate a recommended list of medical applications, in accordance with the method described in step 106 of FIG. 1A or step 156 of FIG. 1B. If the request forwarded to filtering module 716 is for prescription by a physician, filtering module 716 filters medical applications based on medical information associated with a physician-patient encounter and feature information associated with medical applications to generate a recommended list of medical applications, in accordance with the method described in step 406 of FIG. 4.

Interface module 718 outputs for display the list of applications narrowed down by filtering module 716. Interface module 718 may output the list of applications by transmitting information related to the list of applications, via network 706, to client 702. Then, client 702 displays the information related to the list of applications on a user display. Interface module 718 may also transmit instructions (such as HTML codes) that direct client 702 to arrange the display in accordance with the screens described in FIGS, 2, 3 and 5.

When query module 714 receives a request regarding a physician's prescription of a medical application, integration module 720 may store the prescription in EHR database 732. In addition, integration module 720 may receive medical data collected by medical applications. After the patient purchases or downloads a medical application and starts to use the application, the application may collect medical data from the patient user and send the collected data to the EHR system. For example, once a patient starts to use software medical application 742 running on device 740, device 740 might send medical data collected by software medical application 742 to server 710. Although FIG. 7 depicts a medical application as software application 742 running on device 740, medical applications may be a hardware device. Thus, in another example embodiment, another medical application may be device 740. After integration module 720 receives collected medical data, integration module 720 integrates the collected medical data into EHR database 732. In some embodiments, the medical data collected by a medical application is saved as a part of a patient's PCHR.

Enforcement module 722 enforces the purchase, download, and usage of medical applications. For example, enforcement module 722 may send a message to the user, informing the user how to purchase or download a medical application. If the medical application is a software application, the message may additionally provide instructions for the user to download the medical application. If the medical application is prescribed by a physician, enforcement module 722 may periodically check for indication of the purchase or download status of the prescribed medical application. If no such indication has been received within a predefined time period, enforcement module 722 may keep sending reminder messages to the patient and warning messages to the physician to ensure that the patient complies with the physician's prescription. In some embodiments, even after the patient has purchased or downloaded the prescribed medical application, enforcement module 722 may work with integration module 720 to ensure that the patient uses the medical application regularly. For example, if integration module 720 rarely receives medical data from a purchased or downloaded medical application, enforcement module 722 may determine that the patient is not using the medical application regularly. Consequently, enforcement module 722 may send reminder messages to the patient or warning messages to the patient's physician to enforce the compliance of application usage.

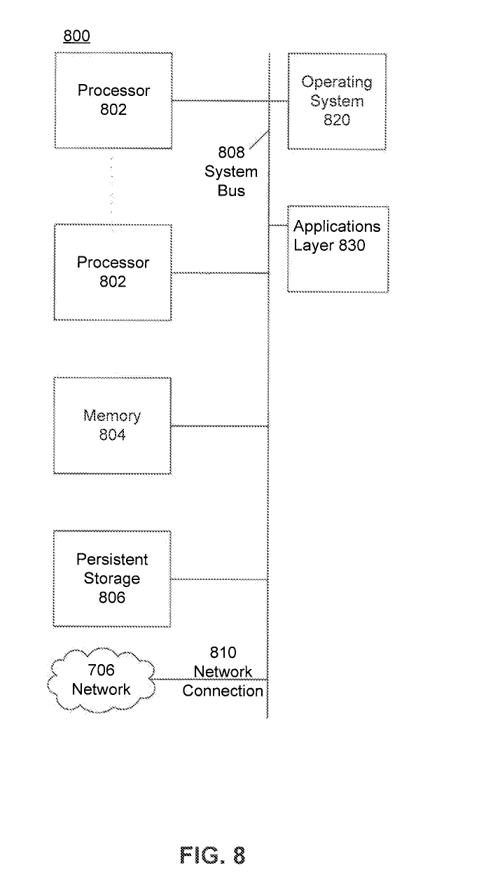

An example computing device is illustrated in FIG. 8. FIG. 8 is a diagram illustrating a computing device 800 that accesses a network 706 over a network connection 810 that provides computing device 800 with telecommunications capabilities. Computing device 800 uses an operating system 820 as software that manages hardware resources and coordinates the interface between hardware and software.

In an embodiment, computing device 800 contains a combination of hardware, software, and firmware constituent parts that allow it to run an applications layer 830. Computing device 800, in embodiments, may be organized around a system bus 808, but any type of infrastructure that allows the hardware infrastructure elements of computing device 800 to communicate with and interact with each other may also be used.

Processing tasks in the embodiment of FIG. 8 are carried out by one or more processors 802. However, it should be noted that various types of processing technology may be used here, including multi-core processors, multiple processors, or distributed processors. Additional specialized processing resources such as graphics, multimedia, or mathematical processing capabilities may also be used to aid in certain processing tasks. These processing resources may be hardware, software, or an appropriate combination thereof. For example, one or more of processors 802 may be a graphics-processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

In order to manipulate data in accordance with embodiments describe herein, processors 802 access a memory 804 via system bus 808. Memory 804 is nontransitory memory, such as random access memory (RAM). Memory 804 may include one or more levels of cache. Memory 804 has stored therein control logic (i.e., computer software) and/or data. For data that needs to be stored more permanently, processors 802 access persistent storage 806 via system bus 808. Persistent storage 806 may include, for example, a hard disk drive and/or a removable storage device or drive. A removable storage drive may be an optical storage device, a compact disc drive, flash memory, a floppy disk drive, a magnetic tape drive, tape backup device, and/or any other storage device/drive.

Processors 802, memory 804, and persistent storage 806 cooperate with operating system 820 to provide basic functionality for computing device 800. Operating system 820 provides support functionality for applications layer 830.

Network connection 810 enables computer device 800 to communicate and interact with any combination of remote devices, remote networks, remote entities, etc. For example, network connection 810 may allow computer device 800 to communicate with remote devices over network 706, which may be a wired and/or wireless network, and which may include any combination of LANs, WANs, the Internet, etc. Control logic and/or data may be transmitted to and from computer device 800 via network connection 810.

Applications layer 830 may house various modules and components. For example, activation module 712, query module 714, filtering module 716, interface module 718, integration module 720, and enforcement module 722 may be included in applications layer 830 when computing device 800 is used as server 710.

It should be noted that computer-readable medium embodiments may include any physical medium which is capable of encoding instructions that may subsequently by used by a processor to implement methods described herein. Example physical media may include floppy discs, optical discs (e.g. CDs, mini-CDs, DVDs, HD-DVD, Blu-ray), hard drives, punch cards, tape drives, flash memory, or memory chips. However, any other type of tangible, persistent storage that can serve in the role of providing instructions to a processor may be used to store the instructions in these embodiments.

### Comprehensive EHR System

A comprehensive EHR system includes a variety of components. Components of EHR systems vary from vendor to vendor and from setting to setting. For example, an EHR system in which embodiments of the present invention can be used may also include, but not be limited to: (1) an electronic prescription (eRx) component, (2) a clinical and radiology laboratory component, (3) a transfer of care component, (4) a scheduling component, (5) a billing service component, and (6) patient portal component.

The electronic prescription component provides medical professionals capabilities to electronically generate and transmit prescriptions for patients' medications. Some EHR systems enable prescribers to view their patients' prescription benefit information at the point of care and select medications that are on formulary and covered by the patient's drug benefit. This informs physicians of potential lower cost alternatives (such as generic drugs) and reduces administrative burden of pharmacy staff and physicians related to benefit coverage.

The clinical and radiology laboratory component allows medical professionals to integrate with clinical laboratories to electronically receive and incorporate clinical laboratory tests and results into a patient's chart and create computerized provider order entry (“CPOE”) clinical laboratory orders. This component can also support functionality that enables medical professionals to electronically receive and incorporate radiology laboratory test results (e.g., x-ray, ultrasound, MRI, PET/CT scan, mammography) into a patient's chart.

Medical professionals can use the transfer of care component to transmit referrals electronically to other EHR users or to non-users by facsimile. Additionally, some EHR systems support electronically creating and transmitting consolidated continuity of care documents.

The scheduling component offers functionality that allows healthcare providers to manage their appointments with an electronic schedule that can be integrated into a practice's workflow.

The billing service component offers medical professionals the ability to electronically generate and transmit superbills. Superbills are the data source for the creation of a healthcare claim. The billing service component can transmit superbills to medical billing software accounts controlled by the professionals' offices or their billing service providers. This component also allows a healthcare professional to save a superbill and transmit it to the health care professional's billing account with the billing software vendor.

The patient portal component allows medical professionals to grant their patients an online means to view, download, and transmit their health information, often called the personal health record (PHR). This component also provides patients with the ability to review their physicians and send and receive secure messages directly to and from their physicians.

Together, these components leverage the benefits of EHRs while mitigating the risks.

### CONCLUSION

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for a physician to electronically prescribe a medical application to a patient, comprising:
(a) activating a plurality of medical applications in an EHR system;
(b) storing feature information associated with each of the activated plurality of medical applications in a database of the EHR system;
(c) receiving a request to retrieve medical applications for an encounter between the physician and the patient;
(d) retrieving medical information describing the encounter from the database of the ERR system;
(e) filtering the plurality of medical applications based on the retrieved medical information describing the encounter and the stored feature information associated with the respective medical application to generate a suggested list of medical applications; and
(f) outputting the suggested list of medical applications to a device for display; and
(g) providing for display the suggested list of medical applications in an output screen that displays information associated with the encounter, including, for each medical application on the suggested list, an option for the physician to electronically prescribe the medical application, wherein the option allows the physician to complete prescribing the corresponding medical application with one click of the corresponding medical application.

2. (canceled)

3. The method of claim 2, further comprising:
(h) in response to a physician's selection of a prescribed medical application, receiving a prescription of the prescribed medical application from the physician; and
(i) storing the prescription in the patient's PHR in the EHR system.

4. The method of claim 3, further comprising:
(j) sending a message to the patient, the message comprising a link for the patient to purchase the prescribed medical application;
(k) receiving a notification indicating that the patient has purchased prescribed medical application,
(l) receiving medical data collected by the prescribed medical application; and
(m) storing the medical data in the patient's PHR in the EHR system.

5. The method of claim 3, further comprising:
(j) determining that a notification indicating that the patient has purchased or downloaded the prescribed medical application is absent within a predefined time period; and
(k) sending a reminder message to the patient for purchasing or downloading the prescribed medical application.

6. The method of claim 5, further comprising:
(l) providing for display a warning message in a second output screen associated with a follow-up encounter between the physician and the patient.

7. The method of claim 1, the activating (a) further comprising:
(h) for each medical application in the plurality of medical applications: generating a set of tags describing features of the respective medical application.

8. The method of claim 7, wherein the medical information describing the encounter comprises a medical problem of the patient for the encounter, the filtering (e) further comprising:
(h) comparing the retrieved medical information describing the encounter to a set of tags of a medical application of the plurality of medical applications;
(h) calculating a relevancy score between the medical problem and the set of tags of the medical application;
(i) determining whether the relevancy score exceeds a threshold value; and
(j) when the relevancy score is determined to exceed the threshold value, incorporating the medical application on the suggested list.

9. The method of claim 7, the outputting (f) further comprising:
(i) generating a ranked order of the suggested list based on relevancy scores between the medical applications on the suggested list; and
(j) providing for display the suggested list based on the ranked order.

10. A system for a physician to electronically prescribe a medical application to a patient, comprising:
a computing device;
an EHR database that stores medical records;
an application information database that stores information associated with medical applications;
an activation module, implemented on the computing device, that activates a plurality of medical applications in an EHR system and stores feature information associated with each of the activated plurality of medical applications in a database of the system;
a query module, implemented on the computing device, that receives a request to retrieve medical applications for an encounter between the physician and the patient;
a filtering module, implemented on the computing device, that retrieves medical information describing the encounter from the database of the EHR system and filters the plurality of medical applications based on the retrieved medical information describing the encounter and the stored feature information associated with the respective medical application to generate a suggested list of medical applications; and
an interface module, implemented on the computing device, that outputs the suggested list of medical applications to a device for display and provides for display the suggested list of medical applications in an output screen that displays information associated with the encounter including, for each medical application on the suggested list, an option for the physician to electronically prescribe the medical application, wherein the option allows the physician to complete prescribing the corresponding medical application with one click of the corresponding medical application.

11. (canceled)

12. The system of claim 11, wherein the query module is further configured to:
in response to a physician's selection of a prescribed medical application, receive a prescription of the prescribed medical application from the physician,
the system further comprising:
an integration module, implemented on the computing device, that stores the prescription in the patient's PHR in the EHR system.

13. The system of claim 12, further comprising:
an enforcement module, implemented on the computing device, that
(i) sends a message to the patient, the message comprising a link for the patient to purchase the prescribed medical application;
(ii) receives a notification indicating that the patient has purchased the prescribed medical application;
(iii) receives medical data collected by the prescribed medical application; and
(iv) stores the medical data in the patient's PHR in the EHR system.

14. The system of claim 12, further comprising:
an enforcement module, implemented on the computing device, that
(i) determines that a notification indicating that the patient has purchased the prescribed medical application is missing within a predefined time period; and
(ii) sends a reminder message to the patient for purchasing the prescribed medical application.

15. The system of claim 14, wherein the enforcement module is further configured to:
provide for display a warning message in a second output screen associated with a follow-up encounter between the physician and the patient.

16. The system of claim 10, wherein the activation module is further configured to:
for each medical application in the plurality of medical applications: generate a set of tags describing features of the respective medical application.

17. The system of claim 16, wherein the medical information describing the encounter comprises a medical problem of the patient for the encounter, and the filtering module is further configured to:
compare the retrieved medical information describing the encounter to a set of tags of a medical application of the plurality of medical applications;
calculate a relevancy score between the medical problem and the set of tags of the medical application;
determine whether the relevancy score exceeds a threshold value; and
when the relevancy score is determined to exceed the threshold value, incorporate the medical application on the suggested list.

18. The system of claim 16, wherein the interface module is further configured to:
generate a ranked order of the suggested list based on relevancy scores between the medical applications on the suggested list; and
provide for display the suggested list based on the ranked order.

19. A non-transitory program storage device tangibly embodying a program of instructions executable by at least one machine to perform a method for a physician to electronically prescribe a medical application to a patient, said method comprising:
(a) activating a plurality of medical applications in an EHR system;
(b) storing feature information associated with each of the activated plurality of medical applications in a database of the EHR system;
(c) receiving a request to retrieve medical applications for an encounter between the physician and the patient;
(d) retrieving medical information describing the encounter from the database of the EHR system;
(e) filtering the plurality of medical applications based on the retrieved medical information describing the encounter and the stored feature information associated with the respective medical application to generate a suggested list of medical applications; and
(g) outputting the suggested list of medical applications to a device for display; and
(g) providing for display the suggested list of medical applications in an output screen that displays information associated with the encounter, including, for each medical application on the suggested list, an option for the physician to electronically prescribe the medical application, wherein the option allows the physician to complete prescribing the corresponding medical application with one click of the corresponding medical application.

20. (canceled)
